(19) United States
(12) Patent Application Publication
(10) Pub. No.: US 2012/0131454 A1
(43) Pub. Date: May 24, 2012

(54) Activating an advertisement by performing gestures on the advertisement

(75) Inventor: Siddharth Shah, Fresno, CA (US)

(73) Assignee: Siddharth Shah, Fresno, CA (US)

(21) Appl. No.: 12/953,826

(22) Filed: Nov. 24, 2010

(51) Int. Cl. G06F 3/01

(52) U.S. Cl. 715/702

(57) ABSTRACT

An advertisement shown on a device with a touch-sensitive display may be activated via gestures performed on the touch-sensitive display. The advertisement is activated if contact with the display corresponds to a predefined gesture for activating the advertisement. The device may display on the touch-sensitive display an indication of a user's progress toward activating the advertisement. The device may also display visual cues of the predefined gesture on the touch-sensitive display to remind a user of the gesture.

### BACKGROUND OF THE INVENTION

The present invention relates generally to user interfaces that employ touch-sensitive displays, and more particularly, to the activating of advertisements on devices with touch-sensitive displays.

Touch-sensitive displays, alternatively referred to as “touch screens” or “touchscreens”, are common in the art and are popular as displays and user input devices on portable devices, such as mobile phones and tablets. Touch screens display graphics and text, as well as provide a means for the user to interact with the device through contact with the touch screen. A device may display user-interface objects on the touch screen; a user may interact with the device by contacting the touch screen at locations corresponding to the user-interface objects with which s/he wishes to interact. Unintentional contact with the touch screen may cause unintentional activation of functions.

Displaying advertisements on devices with touch screens is becoming popular. An advertisement is shown on the touch screen display of the device; a user may activate the advertisement by contacting the touch screen at a location corresponding to the advertisement. Activating an advertisement may entail displaying a website or downloading an application or other program code, or performing other actions specific to the advertisement. The number of activations of an advertisement may contribute directly or indirectly to the fee charged to the advertiser for displaying the advertisement and possibly additional related services.

One problem associated with displaying advertisements on devices with touch screens is unintentional activation of advertisements due to an unintentional contact with the touch screen at a location corresponding to the advertisement. This unintentional activation, also known as an “accidental click,” may contribute directly or indirectly to charges to the advertiser and to a misrepresentation of the successfulness of the advertisement. It may also affect the user experience adversely by interrupting the user while s/he is interacting with the device. Some companies have established policies or guidelines for placing and/or formatting advertisements in ways that reduce the chance of accidental clicks occurring, but the guidelines are not easily or routinely enforced and they do not consider the advertisement activating procedure as a preventative measure (AdMob, Zilic, Google).

Accordingly, there is a need for advertisement activating procedures that are more advertiser-friendly and user-friendly by reducing accidental clicks. Meeting this need may require sensory feedback to the user regarding progress towards the completion of the action that will cause advertisement activation to occur.

### BRIEF SUMMARY OF THE INVENTION

The present invention reduces unintentional activation of an advertisement by requiring more than a simple contact with a touch-sensitive display at a location corresponding to the advertisement to activate the advertisement. The present invention can be automatically enforced by persons providing the advertisements to publishers by, for example, implementing it in the advertising display module's computer code. The present invention also does not interrupt the user, as would some other approaches, such as displaying a confirmation dialog after the user taps an advertisement to confirm that the tap was intentional.

In some embodiments, a method of activating an advertisement displayed on a device with a touch-sensitive display includes: detecting contact with the touch-sensitive display at a location corresponding to an advertisement; and activating the advertisement only if the detected contact corresponds to a predefined gesture.

In some embodiments, a method of activating an advertisement displayed on a device with a touch-sensitive display, includes: displaying text or an image on the touch-sensitive display; detecting contact with the touch-sensitive display; and activating an advertisement only if the detected contact corresponds to moving the text or image to a predefined location on the touch-sensitive display or along a predefined path.

In some embodiments, a method of activating an advertisement displayed on a device with a touch-sensitive display includes: detecting a single contact with the touch-sensitive display at a location corresponding to an advertisement; and activating the advertisement only if another single contact is detected at a location corresponding to the advertisement.

The aforementioned methods may be performed by a device with a touch-sensitive display that may in some embodiments provide a plurality of functions.

### DESCRIPTION OF THE DRAWINGS

For a better understanding of the aforementioned embodiments of the invention—as well as additional embodiments thereof—reference should be made to the following figures and their descriptions, in which like reference numerals refer to corresponding parts throughout the figures.

A description of common parts of the figures follows and is applicable throughout the figures. Touch screen 994 is a device's touch-sensitive display, on which an advertisement is displayed and through which a user can interact with the advertisement. It does not form any part of the claimed invention and is included in the figures for illustrative and explicative purposes only. Advertisement 995 is an advertisement that utilizes one or more embodiments of the invention. It may include text, graphics, video, sound, or any combination of these elements. Visual cue of gesture 996 is a visual cue of the predefined gesture that will activate the advertisement. The visual cue may include graphics, text, or any combination of these elements. Indicator of progress toward gesture 997 is one or more user interface objects that provide sensory feedback to a user regarding progress towards satisfaction of a user input condition that is required for the advertisement activation to occur. Text or image 998 is text or an image that may be moved to a predefined location or along a predefined path to activate the advertisement. User 999 is a user of the device. To maintain clarity of the figures, only a hand with a single extended finger is shown, but the user may use multiple fingers, a stylus, or other means of contacting the touch-sensitive display.

FIG. 1 illustrates an advertisement 995 displayed on a touch screen 994. A visual cue of the gesture 996 is not shown.

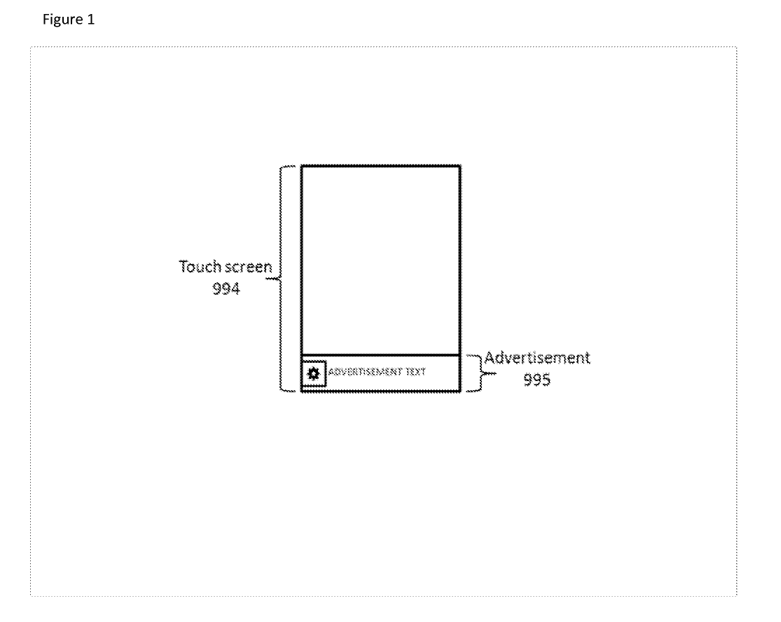

FIG. 2 illustrates an advertisement 995 displayed on a touch screen 994. A visual cue of the gesture 996 is shown.

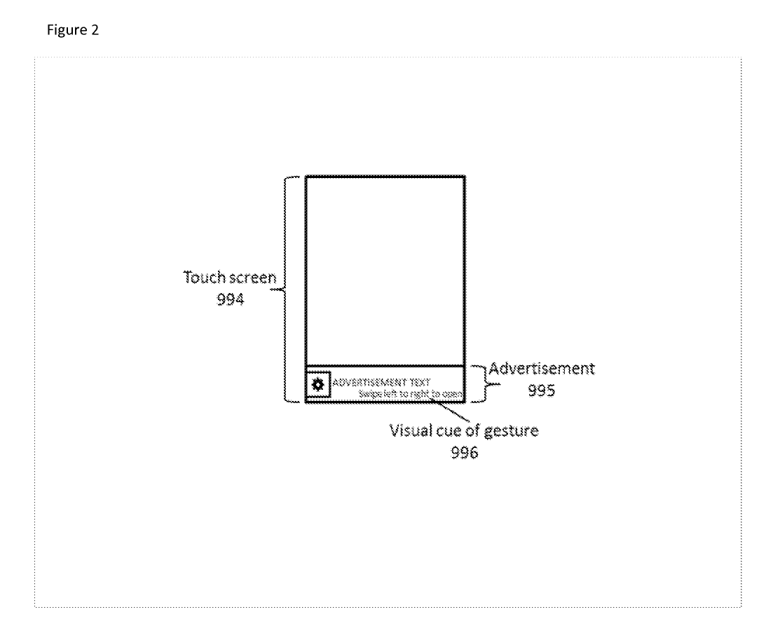

FIG. 3 illustrates an advertisement 995 displayed on a touch screen 994; a visual cue of the gesture 996 is shown after the user 999 has made contact with the touch screen 994 at a location corresponding to the advertisement 995.

FIG. 4 illustrates an advertisement 995 displayed on a touch screen 994; an indicator of progress toward gesture 997 is shown after the user 999 has made contact with the touch screen 994 at a location corresponding to the advertisement 995.

FIG. 5 illustrates an advertisement 995 displayed on a touch screen 994; shown is a text or image 998 that must be moved to a predefined location or along a predefined path to activate the advertisement 995. A visual cue of gesture 996 is not shown.

FIG. 6 illustrates an advertisement 995 displayed on a touch screen 994; shown is a text or image 998 that must be moved to a predefined location or along a predefined path to activate the advertisement 995. A visual cue of gesture 996 is shown.

FIG. 7 illustrates an advertisement 995 displayed on a touch screen 994; the advertisement 995 shows a text or image 998 that must be moved to a predefined location or along a predefined path to activate the advertisement 995. A visual cue of the gesture 996 is shown after the user 999 has made contact with the touch screen 994 at a location corresponding to the advertisement 995.

FIG. 8 illustrates an advertisement 995 displayed on a touch screen 994; shown is a text or image 998 that must be moved to a predefined location or along a predefined path to activate the advertisement 995. An indicator of progress toward gesture 997 is shown after the user 999 has made contact with the touch screen 994 at a location corresponding to the advertisement 995.

FIG. 9 illustrates an advertisement 995 displayed on a touch screen 994; a visual cue of the gesture 996 is shown after the user 999 has made a single contact with, or tap on, the touch screen 994 at a location corresponding to the advertisement 995.

FIG. 10 illustrates an advertisement 995 displayed on a touch screen 994; a different part of the advertisement 995 is displayed after the user 999 has made a single contact with, or tap on, the touch screen 994 at a location corresponding to the advertisement 995.

FIG. 11 is a flow diagram illustrating a process for activating an advertisement, according to some embodiments of the invention.

FIG. 12 illustrates successful completion of an advertisement activation action, according to some embodiments of the invention in which path 992 of the user contact to its final location 993 determines success or failure of the gesture.

FIG. 13 illustrates successful completion of an advertisement activation action, according to some embodiments of the invention in which final location 993 of the user contact determines success or failure of the gesture.

FIG. 14 illustrates successful completion of an advertisement activation action, according to some embodiments of the invention in which the final location 993 of the activation text or image 998 determines success or failure of the gesture.

FIG. 15 illustrates successful completion of an advertisement activation action, according to some embodiments of the invention in which the path 992 of the activation text or image 998 to its final location 993 determines success or failure of the gesture.

FIG. 16 is a flow diagram illustrating a process for determining whether to activate an advertisement, according to some embodiments of the invention. The advertisement 995 is activated if a single contact with, or tap on, the touch screen 994 at a location corresponding to the advertisement 995 is detected and another such tap is detected within a specified time interval.

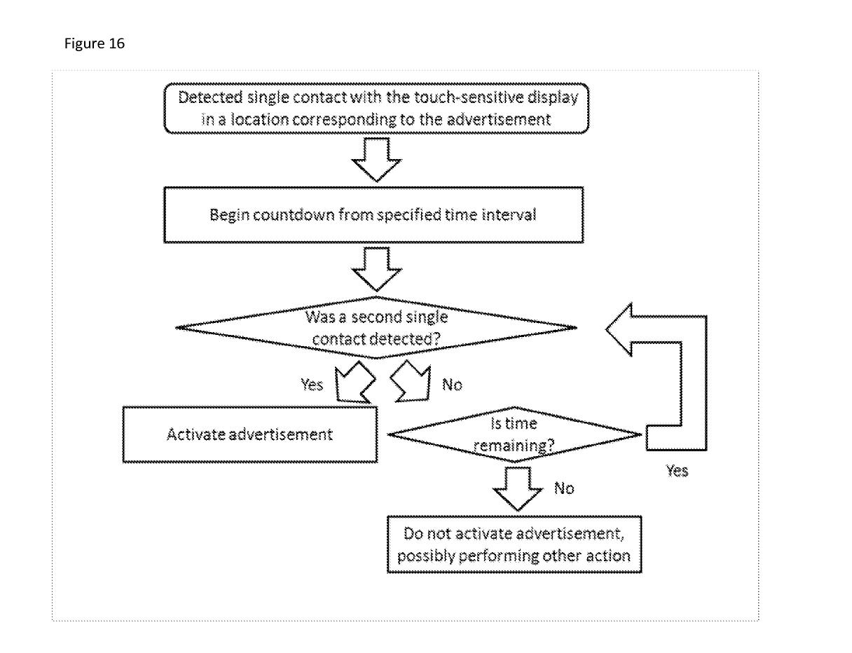

### DETAILED DESCRIPTION OF THE INVENTION

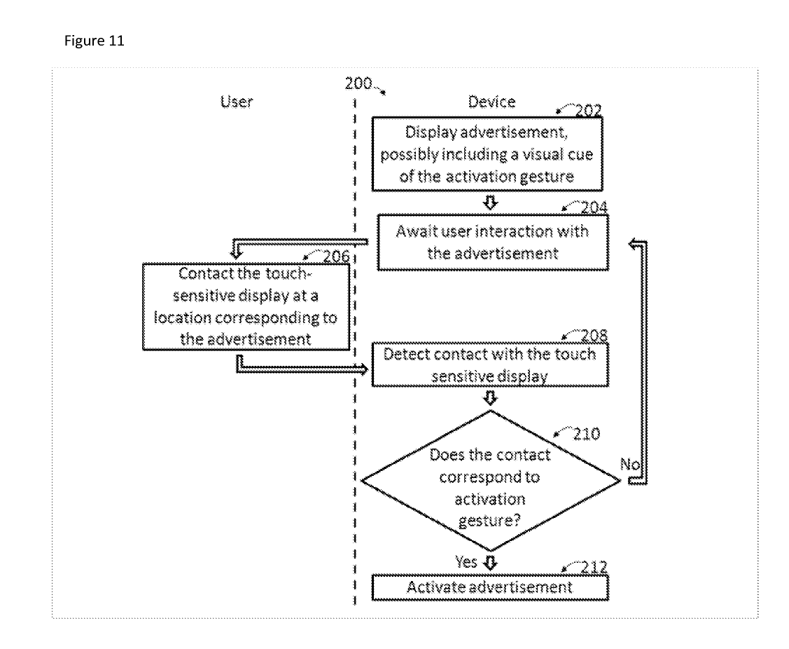

FIG. 11 is a flow diagram illustrating a process 200 for activating an advertisement, according to some embodiments of the invention. While the process flow 200 described below includes a number of operations that appear to occur in a specific order, it should be apparent that these processes may include more or fewer operations, which may be executed in series or in parallel.

An advertisement is displayed on a touch screen (202). In some embodiments, the touch screen may display one or more visual cues of an activation action that the user may perform to activate the advertisement. The visual cue/cues provides/provide hints or reminders of the activation action to the user. In some embodiments, the visual cue/cues may be displayed upon particular user inputs, such as the user making contact with the touch screen at a location corresponding to the advertisement.

The activation action includes contact with the touch screen. In some embodiments, the activation action is a predefined gesture performed on the touch screen. As used herein, a gesture is a motion of an object/appendage making contact with the touch screen. For example, a gesture may include a contact of the touch screen on the left side of the touch screen (initializing the gesture), a horizontal movement of the point of contact to a point on the right side of the touch screen, and a breaking of the contact at that second point (completing the gesture). In some embodiments, the activation action is two taps on the touch screen performed in succession; in some embodiments, the time between the two taps must not exceed a predefined limit.

While the advertisement is displayed, the user may initiate contact with the advertisement by, for example, touching the touch screen at a location corresponding to the advertisement (206). For convenience, contact on the touch screen in the process 200 and in other embodiments described below will be described as performed by the user using at least one hand and one or more fingers. However, the contact may be made with any appropriate object or appendage, such as a stylus. The contact may include one or more taps on the touch screen, continuous contact with the touch screen, movement of the point of contact while maintaining continuous contact, a breaking of the contact, or any combination of these.

The device detects the contact at a location corresponding to the advertisement (208). If the contact does not correspond to an attempt to perform the activation action or if the contact corresponds to a failed or aborted attempt to perform the activation action (210—no), then the advertisement is not activated. For example, if the activation action is a horizontal movement of a point of contact across the touch screen while maintaining continuous contact with the touch screen, and the detected contact is a simple tap on the touch screen, then the advertisement is not activated because the contact does not correspond to the activation action. If, however, the contact does correspond to a successful performance of the activation action (210—yes), then the advertisement is activated (212).

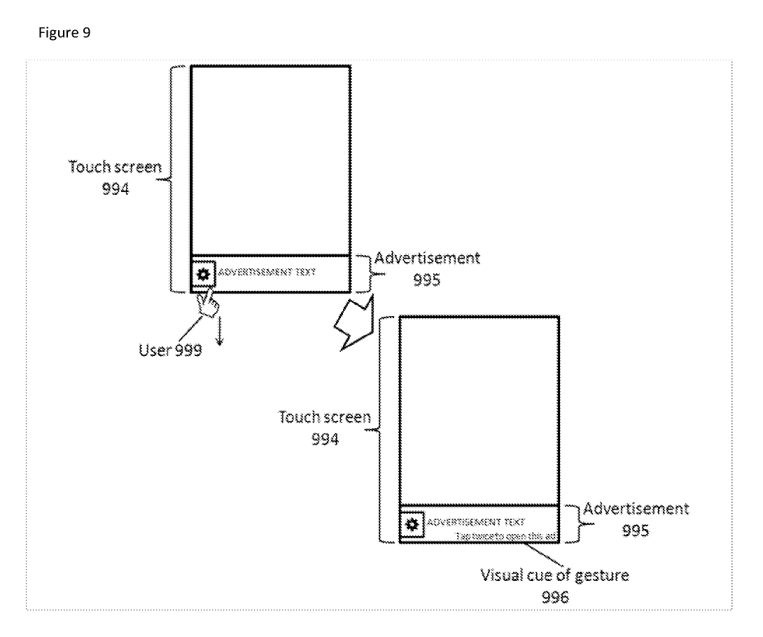

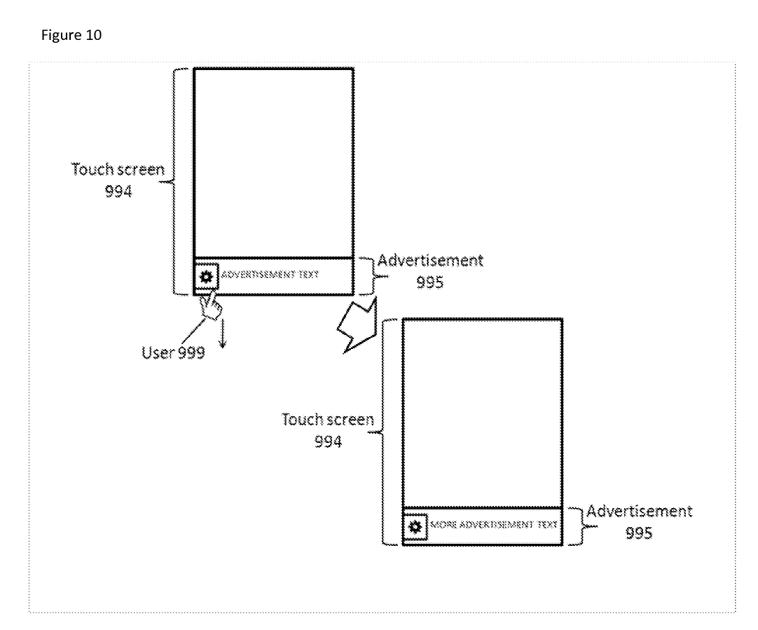

In some embodiments, illustrated for example by FIGS. 9 and 10, the activation action includes contacting the touch screen at a location corresponding to the advertisement, breaking contact with the touch screen soon afterward, and later repeating this pair of actions. In other words, the user must tap twice on the touch screen at locations corresponding to the advertisement (the locations of the two taps may be the same or different). In some embodiments, advertisement activation requires that the second tap must occur within a predefined time limit after the first tap occurred. In some embodiments, a visual cue of the gesture and/or an indicator of progress toward activation may be displayed before the first tap or after the first tap. In some embodiments, additional parts of the advertisement (including graphics, text, sound, or any combination thereof) may be loaded and/or displayed after the first tap, as illustrated for example by FIG. 10.

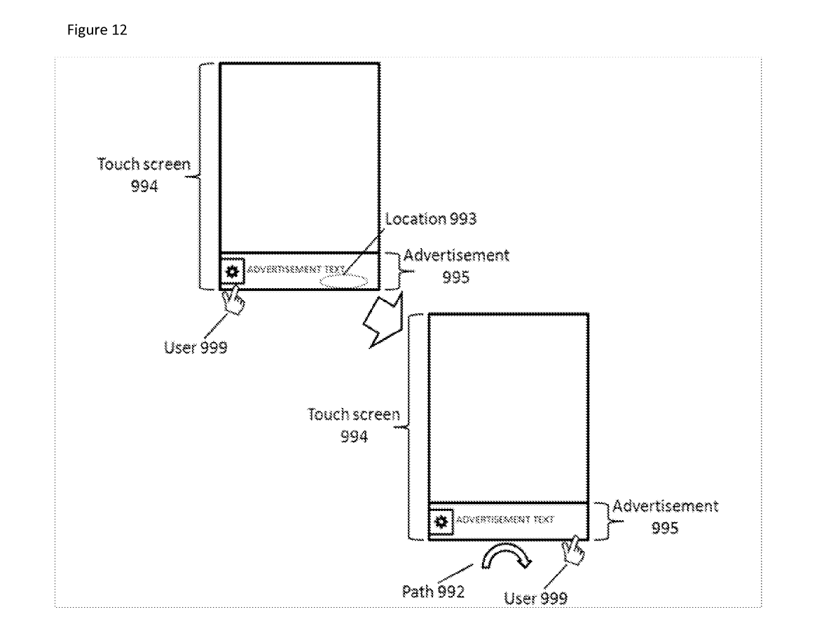

In some embodiments, the activation action includes contacting the touch screen at a location corresponding to the advertisement and maintaining continuous contact with the touch screen in a predefined path, to any spot within a predefined region on the touch screen. In the example illustrated by FIG. 12, the predefined path (992) is arch-shaped. The success or failure of the advertisement activation action is determined by the path of the contact, and not by the final location of the user input device (such as a finger or stylus). Because the path is the factor that determines success, the final location of the user input device (993) may be defined broadly. The predefined path may include one or more straight-line segments or curved segments. In some embodiments, the activation action is completed by breaking contact with the touch screen upon completion of the predefined gesture. Upon the successful completion of the action, the advertisement is activated.

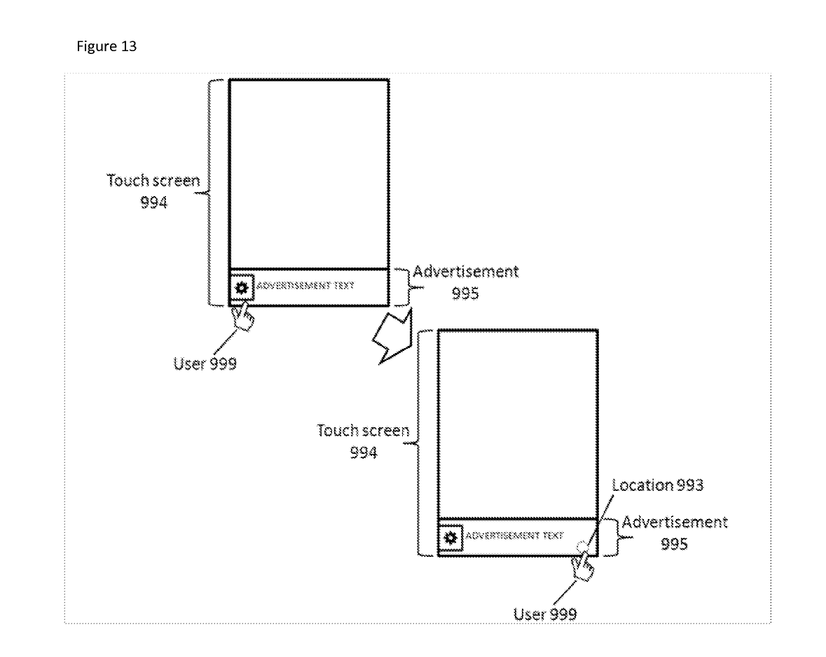

In some other embodiments, as illustrated for example by FIG. 13, the activation action includes contacting the touch screen at a location corresponding to the advertisement and maintaining continuous contact with the touch screen while moving the user input device to a location (993) on the touch screen that meets one or more predefined activation criteria. The final location of the user input device, and not the path by which it arrives there, determines success or failure of the gesture. Thus, the user can make continuous contact with the touch screen in any path, and as long as it reaches the predefined location, the advertisement is activated. In some embodiments, the activation action is completed by breaking the contact with the touch screen at a location on the touch screen that meets one or more predefined activation criteria.

A location meeting one or more predefined activation criteria is simply a location on the touch screen that is predefined as a location to which the activation text or image must be dragged in order to activate the advertisement. Multiple locations can meet the predefined activation criteria. The location(s) may be defined as a region on the touch screen, particular locations on the touch screen, or any combination. For example, the location may be defined as a single particular location or as the right half of the region of the touch screen that corresponds to the location of the advertisement.

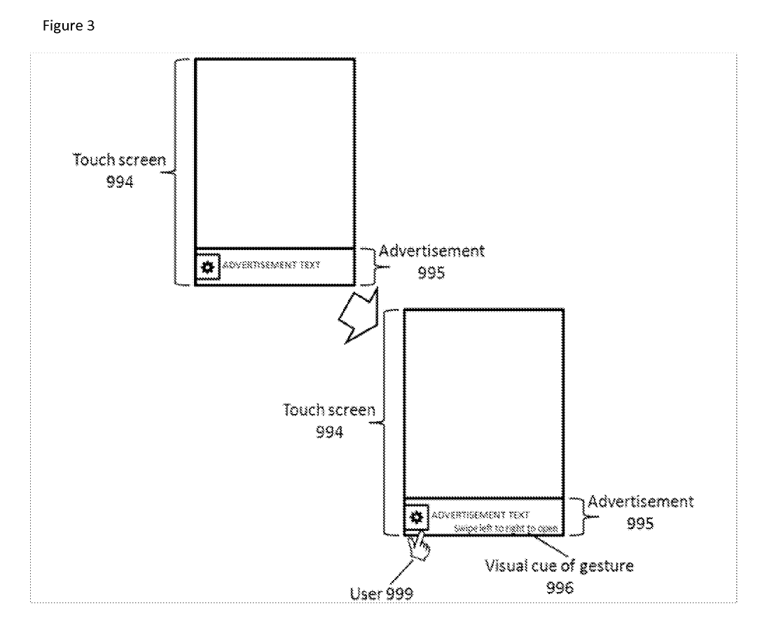

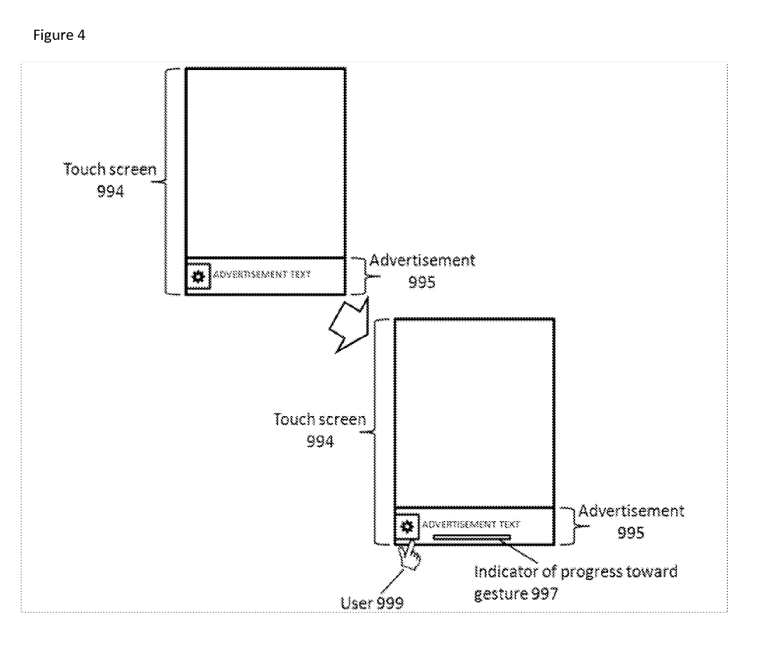

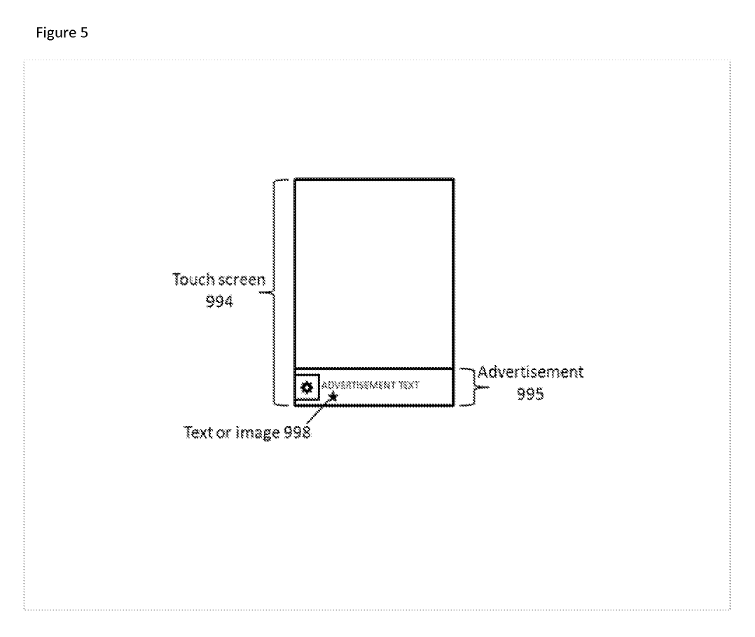

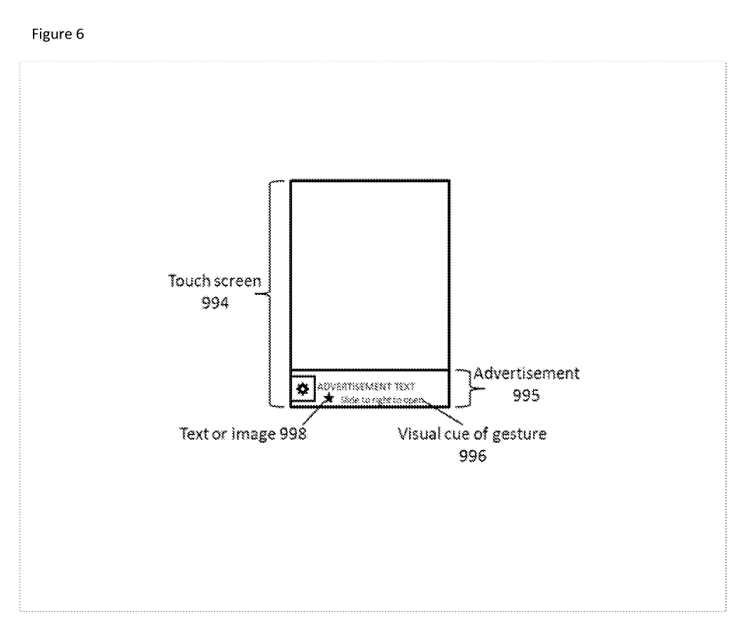

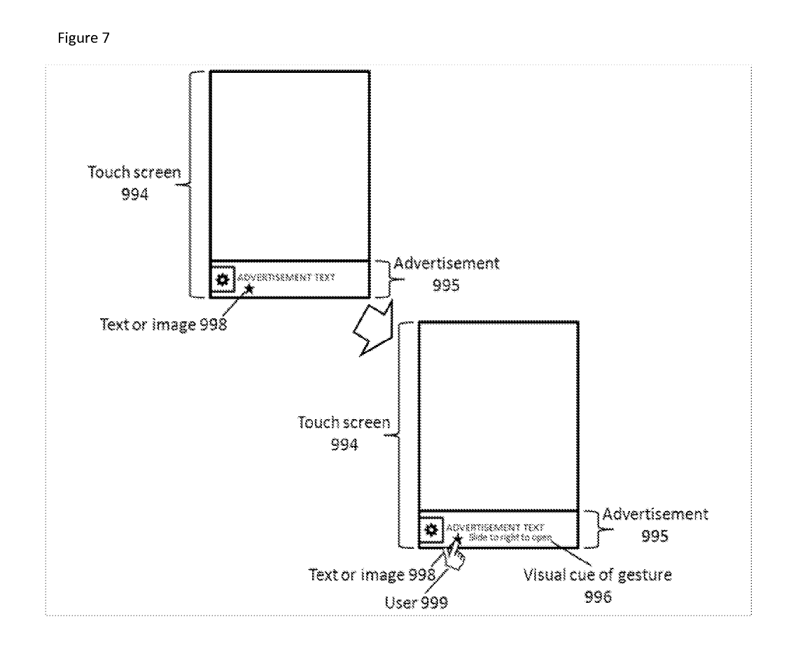

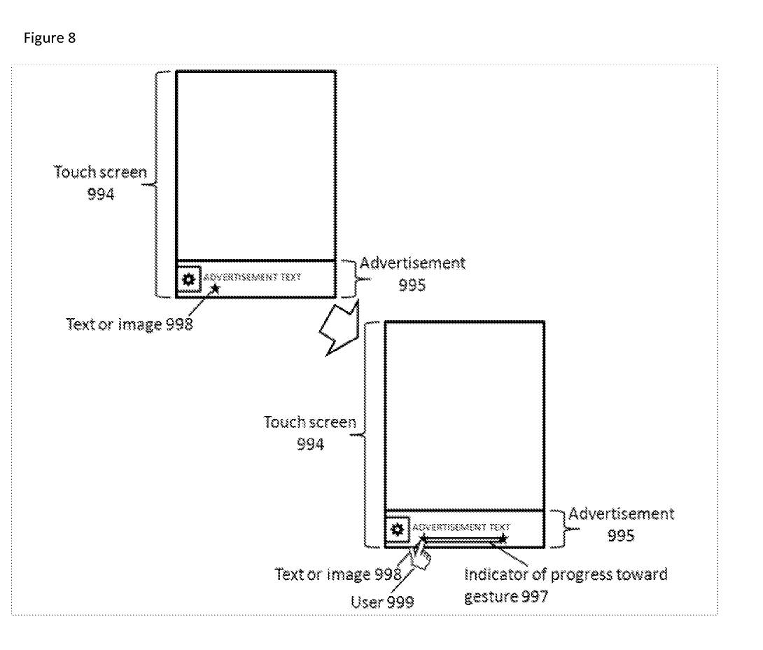

In some embodiments, as illustrated for example by FIGS. 3-8, the device may display a text or image with which the user interacts to activate the advertisement. For example, the activation action may require dragging the activation text or image in a predefined manner or path. In some embodiments, the gesture includes dragging the text or image to a location on the touch screen that meets one or more predefined activation criteria. In other words, the user makes contact with the touch screen at a location corresponding to the activation text or image and then performs the predefined gesture while maintaining continuous contact with the touch screen, dragging the text or image to the location that meets the predefined activation criteria. In some embodiments, the activation action is completed by breaking the contact with the touch screen (thus releasing the activation text or image) upon completion of the predefined gesture.

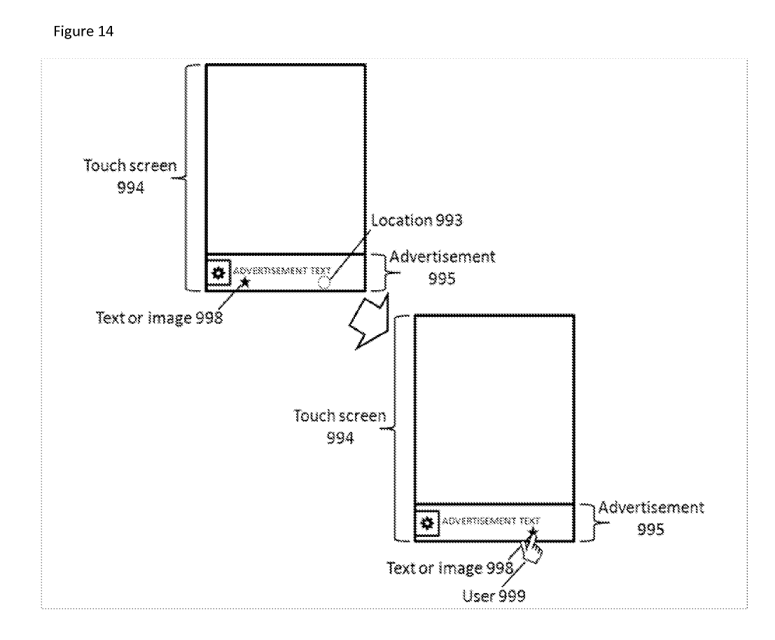

In some embodiments, as illustrated for example by FIG. 14, the interaction includes dragging the activation text or image to a predefined location on the touch screen. The final location of the activation text or image (993), not the path by which it arrives there, determines success or failure of the gesture. Thus, the user can drag the activation text or image from its initial location along any path, and as long as it is released at the predefined location, the advertisement is activated. The predefined location may be declared as above.

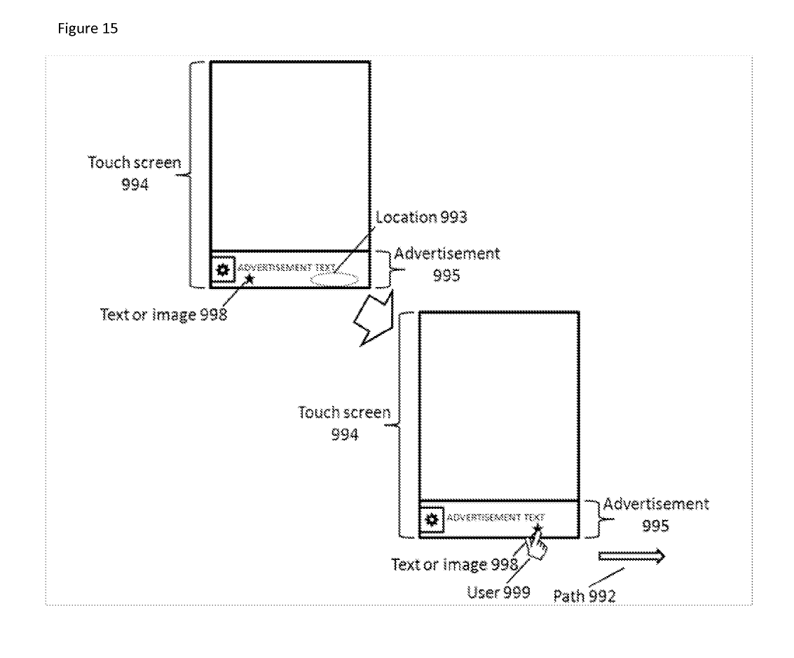

In some other embodiments, the activation action includes dragging the activation text or image along a predefined path. As illustrated for example by FIG. 15, the activation action may include dragging the activation text or image from its initial location to another location (993) in a linear path (992). The path by which the activation text or image arrives at its final location determines success or failure of the gesture. Because the path is the factor that determines success, the final location of the activation text or image may be defined broadly. For example, the activation action may be to drag the activation text or image from its initial location, along the predefined path, to any spot within a predefined region on the touch screen. The predefined path may include one or more straight-line segments or curved segments.

In order to reduce clutter and improve clarity, FIGS. 12-15 do not include other elements of some embodiments of the invention, such as one or more visual cues of the activation gesture and an indicator that provides sensory feedback to a user regarding progress towards satisfaction of a user input condition that is required for the advertisement activation to occur. However, it should be appreciated that some embodiments may include any number of either of these elements separately or in combination.

What is claimed is:

1. A method of activating an advertisement displayed on a device with a touch-sensitive display, comprising: detecting contact with the touch-sensitive display at a location corresponding to an advertisement;
and activating the advertisement only if the detected contact corresponds to a predefined gesture.

2. The method of claim 1, further comprising, before the advertisement has been activated, displaying on the touch-sensitive display one or more visual cues of the predefined gesture.

3. The method of claim 1, further comprising, displaying on the touch-sensitive display one or more visual cues of the predefined gesture when contact with the touch-sensitive display is detected at a location corresponding to the advertisement.

4. The method of claim 1, further comprising, displaying an indicator of progress toward the predefined gesture as a gesture is being input.

5. A method of activating an advertisement displayed on a device with a touch-sensitive display, comprising: displaying text or an image on the touch-sensitive display;
detecting contact with the touch-sensitive display;
and activating an advertisement only if the detected contact corresponds to moving the text or image to a predefined location on the touch-sensitive display or along a predefined path.

6. The method of claim 5, further comprising, before the advertisement has been activated, displaying on the touch-sensitive display one or more visual cues of the predefined gesture.

7. The method of claim 5, further comprising, displaying on the touch-sensitive display one or more visual cues of the predefined gesture when contact with the touch-sensitive display is detected at a location corresponding to the advertisement.

8. The method of claim 5, further comprising, displaying an indicator of progress toward the predefined gesture as a gesture is being input.

9. A method of activating an advertisement displayed on a device with a touch-sensitive display, comprising: detecting a single contact with the touch-sensitive display at a location corresponding to an advertisement;
and activating the advertisement only if another single contact is detected at a location corresponding to the advertisement.

10. The method of claim 9, further comprising, before the advertisement has been activated, displaying on the touch-sensitive display one or more visual cues of the method.

11. The method of claim 9, further comprising, displaying on the touch-sensitive display one or more visual cues of the method when the first described contact is detected.

12. The method of claim 9, further comprising, displaying on the touch-sensitive display a different part of the advertisement when the first described contact is detected.

13. The method of claim 9, further comprising, activating the advertisement only if the second described contact is detected within a specified time interval after the first described contact.
